(19) United States
(12) Patent Application Publication
(10) Pub. No.: US 2018/0248206 A1
(43) Pub. Date: Aug. 30, 2018

(54) COOLING SYSTEM FOR A FUEL CELL, AND A FUEL CELL SYSTEM

(71) Applicants: Volkswagen AG, Wolfsburg (DE); AUDI AG, Ingolstadt (DE)

(72) Inventors: Jan Denecke, Braunschweig (DE); Nadine Gruenheid, Wolfsburg (DE)

(21) Appl. No.: 15/755,429

(22) PCT Filed: Aug. 24, 2016
(86) PCT No.: PCT/EP2016/069957

§ 371 Date: Feb. 26, 2018

(30) Foreign Application Priority Data
Aug. 28, 2015 (DE) 10 2015 216 513.2

(51) Int. Cl. H01M 8/04007; H01M 8/04029; B60L 11/18

(52) U.S. Cl. CPC H01M 8/04037; H01M 8/04029; H01M 2250/20; B60L 11/1892; B60L 11/1894; H01M 8/04074

(57) ABSTRACT

The invention relates to a cooling system (100) for a fuel cell (12) of a fuel-cell vehicle, with a cooling circuit (10) that includes the fuel cell (12), a coolant pump (16) that conveys a coolant, a radiator (18), a coolant line (30) that transports the coolant, and an electric heater (24) for warming the coolant, as well as a fuel-cell system having such a cooling circuit.

It is provided that the heater (24) be designed as a heating line (25) which extends along at least a part of the coolant line (30).

The invention relates to a cooling system for a fuel cell of a fuel-cell vehicle, with a cooling circuit that includes the fuel cell, a coolant pump that conveys a coolant, a radiator, a coolant line that transports the coolant, and an electric heater for warming the coolant, as well as a fuel-cell system having such a cooling circuit.

Fuel cells use the chemical conversion of hydrogen and oxygen into water in order to generate electrical energy. For this purpose, fuel cells contain as their core component the so-called membrane electrode assembly (MEA), which features a combination of a proton-conducting membrane and electrodes arranged on each side of the membrane. The electrodes have a catalytic layer that is applied either to a gas-permeable substrate or directly on the membrane. During operation of the fuel cell, hydrogen H₂ or a gas mixture containing hydrogen is guided to the anode, where an electrochemical oxidation of the hydrogen to H⁺ with loss of electrons takes place. Via the membrane, which separates the reaction chambers gas-tightly from one another and electrically insulates them, the protons H⁺ are transported (in a water-bound or water-free manner) from the anode chamber into the cathode chamber by means of diffusion. The electrons provided at the anode are guided to the cathode via an electrical line. The cathode is further supplied with oxygen or a gas mixture containing oxygen, so that a reduction of oxygen to O²⁻ with gain of electrons takes place. At the same time, these oxygen anions react in the cathode chamber with the protons, while forming water. A fuel-cell system generally includes a plurality of membrane-electrode units in stacks, wherein, usually externally on the electrodes, a porous gas diffusion layer for homogeneous supply of the reaction gases to the electrodes is arranged. As a result of the direct conversion of chemical into electrical energy, fuel cells achieve improved efficiency compared to thermal engines, because the Carnot factor is avoided.

The fuel-cell technology that is currently the most advanced is based upon polymer electrolyte membranes (PEM), in which the membrane itself is made of a polyelectrolyte. The most common PEM is a membrane made of sulfonated polytetrafluoroethylene (trade name: Nafion®). The electrolytic conduction takes place here via hydrated protons.

Normally, the ongoing reaction creates sufficient heat in the fuel cell during operation to bring the system to appropriate temperatures. Precisely during use of fuel cells in motor vehicle traction systems, however—in particular, at low outside temperatures—this self-warming process can take a certain amount of time, which results in a limited operation in the start-up phase. When using fuel cells for motor-vehicle operation, a quick attainment of the operating temperature at ambient temperatures of, ideally, down to −40° C. is desirable.

The use of an auxiliary heater to achieve the operating temperature with frost or cold start is known from DE 10 2007 054 299 A1. The coolant flows through the auxiliary heater. The auxiliary heater has a heating element via which the coolant is warmed as it flows through the auxiliary heater. The auxiliary heater is a separate component that has a non-negligible space requirement in the fuel-cell system. Because the coolant is to be warmed—in particular, upstream of the fuel cell—the number of possible positions for arranging the auxiliary heater is limited, and negatively influences the installation space situation. In addition, the coolant experiences a pressure loss when flowing through the auxiliary heater, which negatively affects the efficiency of the fuel-cell system.

The invention is now based upon the aim of preparing a cooling system for a fuel-cell system that solves the problems of the prior art and, in particular, takes up less installation space.

This aim is achieved by a cooling system for a fuel cell having the features of the independent claims. A first aspect of the invention therefore relates to a cooling system for a fuel-cell of a fuel-cell vehicle having a cooling circuit. The cooling circuit comprises the fuel cell, a coolant pump that supplies a coolant, a radiator, a coolant line that transports the coolant, and an electric heater for warming the coolant. According to the invention, the heater is designed as a heating line that extends along at least a part of the coolant line. The advantage of the cooling system according to the invention is, in particular, that an auxiliary heater that takes up space can be omitted from the fuel-cell system. This results in an optimized fuel-cell system package. In addition, a pressure loss that would be created by flowing through an auxiliary heater is prevented. The efficiency of the fuel-cell system is thus increased by the cooling system according to the invention.

In contrast to cooling systems that have an auxiliary heater, the coolant lines of the cooling system according to the invention are heated only in the regions in which it makes sense from the standpoint of efficiency, and not in the regions in which space is available for arrangement of an auxiliary heater inside of the fuel-cell system. This results, to a particular degree, in an efficiency increase in the system, because only the required demand for heat is applied to the coolant at appropriate positions.

According to the invention, the heating line is arranged in one or more sections of the coolant line. In this manner, coolant lines are formed that can be electrically heated. The coolant lines can be rigid lines and/or flexible tubes.

In a preferred embodiment of the invention, the heating line is integrated into at least one part of the coolant line. This results in an optimized use of space. Presently, the heating line is integrated into the coolant line if it is connected to this in a thermally conductive manner. To do this, the heating line can be arranged in the interior of the coolant line, in the interior of a wall of the coolant line, or else outside of the coolant line.

In a particularly preferred embodiment, the heating line is arranged within the coolant line. In this embodiment, the efficiency of the heating line is optimized—particularly if the coolant is in contact with the heating line. In this manner, heat loss via the coolant line is reduced. The coolant line is heated indirectly via the coolant, and not the coolant via the coolant line. Moreover, this embodiment results in a reduced heating phase because the coolant is warmed directly via the heating line, and not indirectly via the coolant line. In particular, two designs are preferred for this embodiment: first, a heating line—arranged in the interior of the coolant line, i.e., in a cavity formed by the line—which is in contact with the coolant line only at certain points and around which, as much as possible, coolant flows. The heating line in this embodiment is designed as a wire or longitudinally extending spiral. Alternatively to this, the coolant line is lined with the heating line. For this purpose, the heating line takes the form of, for example, a coil, a mesh, or a tube, which has an outer diameter that corresponds to the inner diameter of the coolant line.

In an additional embodiment of the invention, it is preferred that the heating line be incorporated into a wall of the coolant line. This embodiment has the advantage that a direct contact between coolant and heating line is avoided. A corrosion of the heating line by the coolant is thus prevented. The requirements for the heating line are reduced with respect to corrosion, and it can be designed for heating efficiency alone. In this embodiment, the coolant is heated indirectly via the coolant line. The heating line in this embodiment is, for example, molded with the coolant line—in particular, with the wall of the coolant line. The heating line is preferably already incorporated into it during the manufacture of the coolant line.

Advantageously, the heating line is arranged on an outer side of the wall of the coolant line. The coolant is thus also heated via the coolant line. The advantage is that this embodiment is more maintenance-free than the alternatives. If there is maintenance work to be done or a defect in the heating line, the heating line is preferably just separated from the cooling line and replaced, without having to remove or open the coolant line of the cooling system.

In a preferred embodiment, the heating line encloses the coolant line in sections—in particular, over the whole circumference of the wall of the coolant line. This means that the heating line is, for example, designed as a sleeve around the coolant line. This embodiment has a particularly high efficiency, because an even heating of the whole coolant line is possible and, with it, a uniformly high heat input. The greater the section of the wall that is heated, the less slow the system is and, therefore, the more effectively and quickly the heat is transferred to the coolant.

In an additional preferred embodiment of the invention, the heating line can be controlled and/or regulated such that a needs-based heat input is possible.

It is also preferred that the heating line be arranged upstream of the fuel cell. In this manner, the coolant can be warmed directly at the point of need, viz., before it is introduced into the fuel cell. This has an especially advantageous effect on the efficiency of the fuel-cell system.

An additional aspect of the invention relates to a fuel-cell system that comprises a cooling system according to the invention.

Additional preferred embodiments of the invention arise from the other features stated in the dependent claims.

The various embodiments of the invention mentioned in this application may be combined advantageously with one another unless stated otherwise in individual cases.

The invention is explained below in exemplary embodiments with reference to the respective drawings. The following is shown:

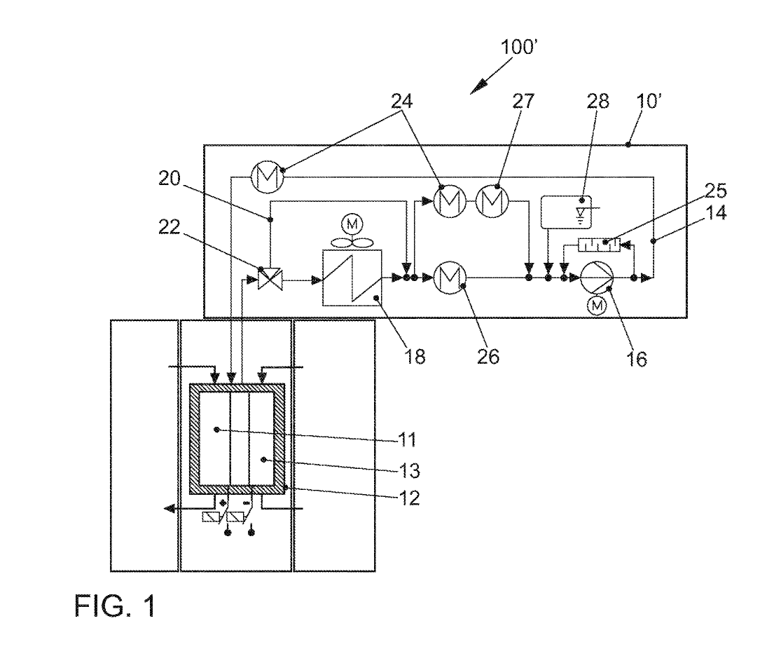

FIG. 1 a fuel-cell cooling system according to the prior art,

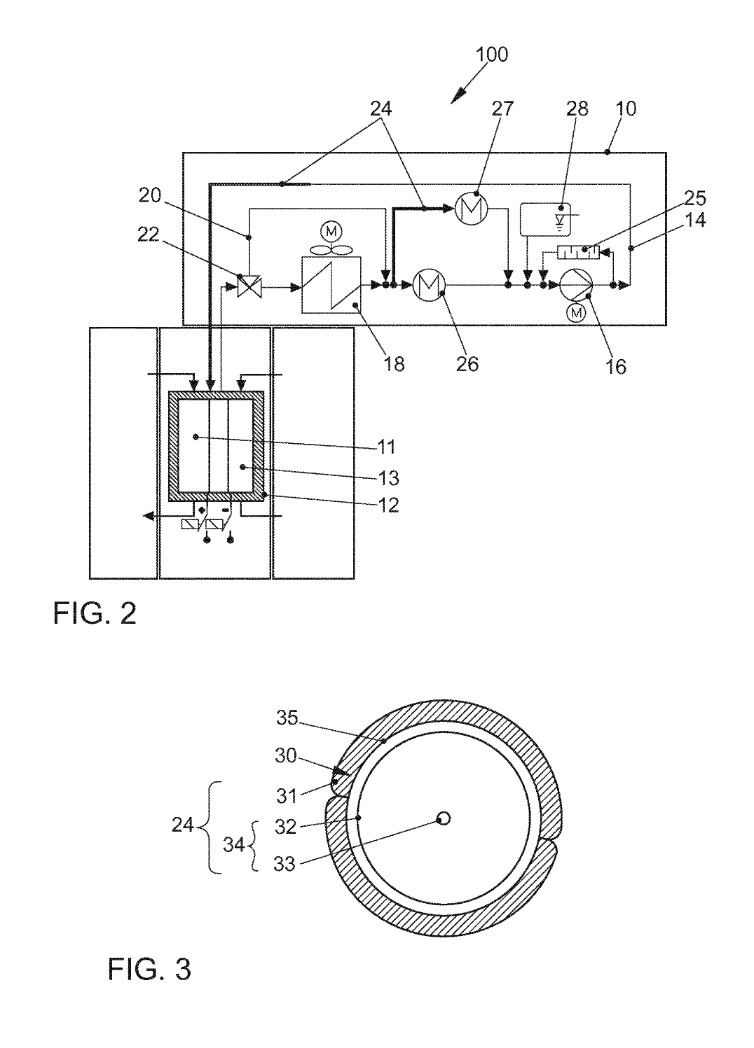

FIG. 2 a fuel-cell cooling system according to a preferred embodiment of the invention, and

FIG. 3 a schematic representation of a cross-section of a coolant line that can be electrically heated, in a preferred embodiment.

FIG. 1 shows in a schematic representation a cooling system according to the prior art, designated as a whole with 100′, that has a cooling circuit 10′ according to the prior art, built from a line system, in which a fuel cell 12 is integrated. Cooling circuit 10′ comprises a main circuit 14 in which a coolant is supplied via a—preferably, electrically operated—coolant pump 16. A radiator 18 also integrated into main circuit 14 serves to cool the coolant warmed by running through fuel cell 12. In addition, main circuit 14 has an intercooler 26, formed as a heat exchanger, and an expansion tank 28 for storing coolant.

Cooling circuit 10′ further comprises a bypass line 20, which goes around radiator 18. In addition, the cooling system can have an interior heat exchanger 27. A thermostat valve 22 is arranged in cooling circuit 10, at a connection point of bypass line 20 and a cooling path of radiator 18, by which the coolant flow can optionally be guided through radiator 18 or through bypass line 20. In order to accelerate the heating of fuel cell 12 after a cold start, the coolant flows solely through bypass line 20, in circumvention of radiator 18. Only after the warming of fuel cell 12 is the coolant guided through radiator 18, in order to maintain fuel cell 12 at a specified temperature. Thermostat valve 22 can preferably be controlled or regulated continuously, so that this can be supplied with a desired mixture ratio of cooled and heated coolant as a function of the temperature of fuel cell 12.

Cooling circuit 10′ according to the prior art has an electric heater 24′ that is integrated into the line system and heats the coolant during its operation. Heater 24′ according to the prior art is designed as an auxiliary heater 24′. Auxiliary heater 24′ is, for example, a heater that has a heating element and is arranged in such a manner that coolant flows through it.

Auxiliary heater 24′ can be integrated into main circuit 14 and connected in series with radiator 18. Other positions of auxiliary heater 24′—for example, downstream of radiator 18 or downstream of coolant pump 16—are conceivable. Alternatively or additionally, auxiliary heater 24′ is connected in bypass line 20 and thereby parallel to radiator 18.

A cooling system 100 according to the invention is shown in FIG. 2. The cooling system 100 comprises a fuel cell 12 having an anode 11 and associated anode circuit 11a, as well as a cathode 13 with cathode circuit 13a. Cooling system 100 also has at least one heater 24 for active warming of the coolant; in contrast to cooling system 100′ according to the prior art, they are not designed as auxiliary heaters 24′, but instead as heating lines 24 that extend along the coolant lines of the coolant.

For a better overview, the arrangement according to the invention of heating lines 24 along a coolant line, i.e., a coolant line 30 that can be electrically heated, is illustrated as a cross-section in FIG. 3. This can, for example, be an exterior arrangement of heating line 31 in the form of a heat sleeve or spirally encircling heating coils that are placed on existing coolant lines. Alternatively, specially heatable cooling lines 30—in particular, hoses—are provided, in which a heating line 24 is integrated. In coolant lines 30 of this type, heating line 24 is, for example, embedded in a wall 35 of line 30—in particular, molded with this. In the interior of coolant line 30, flowing coolant is thus preferably not in contact with the heating line. Moreover, the specialized coolant lines can have integrated heating lines 34 that are in contact with the coolant. These are, for example, interior heating lines 32, 33, e.g., heating wire 32, heating coil or heating mesh 33, which are arranged in the coolant-conducting cavity (in 32)—in particular, on an interior wall 35 of coolant line 30.

Electric heater 24 according to FIG. 2 or 3 is preferably equipped with a power control with which the heating capacity of heater 24 can be controlled or regulated—in particular, continuously.

All other components of cooling system 100 from FIG. 2 correspond to those in FIG. 1 and are not explained again.

Fuel cell 12 from FIG. 1 or 2 is used to operate a vehicle not shown in the figures. For this purpose, it is coupled to an electric motor (also not shown) that serves to operate the vehicle. In addition, an energy store can be provided that is charged in the case of an energy surplus in fuel cell 12 or a braking process of the vehicle.

Cooling system 100 shown in FIG. 2 enables the cold-start capability of fuel cell 12—in particular, the frost-start capability. For this, the temperature of fuel cell 12 must be brought above the freezing point of water in the shortest time possible, so that the fuel-cell reaction is not prevented by ice formation. One possible operating strategy for a cold start is to operate fuel cell 12 at a high load point with low electrical efficiency, and thus heat it up via resulting reaction heat. The high electrical power take-off necessary for this can be transmitted via the electric motor of the vehicle to the vehicle wheels and be used to operate the vehicle. At operating points, however, in which a corresponding load requirement does not exist, e.g., in traffic jam or traffic light phases, this is, operationally, not possible. According to the invention, for heating fuel cell 12 in such situations, i.e., if an actual temperature of the fuel cell is below a target temperature, fuel cell 12 is operated under an electrical load of heater 24, wherein it works with a low efficiency, and the main portion of the supplied fuel (hydrogen) is transformed into heat. In this manner, fuel cell 12 warms itself up. On the other hand, the relatively low proportion of the electrical energy generated is transformed into heat by electrical heater 24, which also serves for fuel-cell warming via the coolant. In other words, in operating situations in which there is no requirement for a drive load, the electrical load is picked up by heater 24, whereby a frost start of fuel cell 12 is made possible or accelerated.

The embodiment of heater 24 according to the invention as a heating line along the coolant lines 30 has the advantage that no additional space requirement is needed for heater 24. The demands on the package are accordingly lower in coolant lines 30 that can be electrically heated. In addition, they are easier to integrate in this arrangement, and thus the necessary heat input can be arranged on-site.

An additional advantage of the heater 24 embedded in the cooling circuit is that, by an accelerated heating of the coolant, the amount of heat that can be transferred via an interior heat exchanger 27 into the passenger cabin is increased. In this manner, there is a fast warming of the vehicle interior, whereby the air heater otherwise required in fuel-cell vehicles can be avoided.

### LIST OF REFERENCE SYMBOLS

100′ cooling system according to the prior art
100 cooling system
10′ cooling circuit according to the prior art
10 cooling circuit
11 anode
11a anode circuit
12 fuel cell
13 cathode
13a cathode circuit
14 cooling system main circuit
16 coolant pump
18 radiator
20 bypass line
22 thermostat valve
24′ electric heater according to the prior art/auxiliary heater
24 electric heater/heating line
25 filter unit
26 intercooler
27 interior heat exchanger
28 expansion tank
30 coolant line that can be electrically heated
31 externally disposed heating line
32 heating wire or coil
33 heating mesh
34 heating line integrated within a coolant line
35 wall

1. A cooling system of a fuel-cell vehicle, comprising:
a cooling circuit including:
a fuel cell;
a coolant pump that conveys a coolant;
a radiator;
a coolant line that transports the coolant; and
an electric heater for warming the coolant, wherein the electric heater is configured as a heating line that extends along at least a portion of the coolant line.

2. The cooling system according to claim 1, wherein the heating line is integrated into at least the portion of the coolant line.

3. The cooling system according to claim 1, wherein the heating line is arranged in an interior of the portion of the coolant line.

4. The cooling system according to claim 1, wherein the heating line is in contact with an interior section of the portion of the coolant line, such that the heating line at least partially lines the portion of the coolant line.

5. The cooling system according to claim 1, wherein the heating line is incorporated into a wall of the portion of the coolant line.

6. The cooling system according to claim 1, wherein the heating line is arranged on an outer side of a wall of the portion of the coolant line.

7. The cooling system according to claim 6, wherein the heating line at least partially encloses the portion of the coolant line over an entire circumference of the wall of the portion of the coolant line.

8. The cooling system according to claim 1, comprising:
a power control that controls and/or regulates heating capacity of the heating line.

9. The cooling system according to claim 1, wherein the heating line is arranged upstream of the fuel cell.

10. A fuel-cell system comprising a cooling system, the cooling system including:
a fuel cell;
a coolant pump that conveys a coolant;
a radiator;
a coolant line that transports the coolant; and
an electric heater for warming the coolant, wherein the electric heater is configured as a heating line that extends along at least a portion of the coolant line.

11. The fuel-cell system according to claim 10, wherein the heating line is integrated into at least the portion of the coolant line.
